(19) United States
(12) Patent Application Publication
(10) Pub. No.: US 2020/0136778 A1
(43) Pub. Date: Apr. 30, 2020

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 16/630,227

(22) PCT Filed: Jul. 13, 2017
(86) PCT No.: PCT/JP2017/025627

§ 371 Date: Jan. 10, 2020

(51) Int. Cl. H04L 5/00; H04W 72/04; H04W 28/06; H04L 27/26; H04W 72/12

(52) U.S. Cl. CPC H04L 5/0053; H04W 72/0413; H04W 72/1263; H04W 28/06; H04L 27/2602; H04W 72/042

(57) ABSTRACT

To appropriately perform communication even when scheduling based on a plurality of time units is supported in a radio communication system, one aspect of a user terminal according to the present invention includes: a control section that controls reception of a DL signal and/or transmission of a UL signal to be scheduled by applying at least one of a first time unit and a second time unit shorter than the first time unit; and a transmission section that transmits the UL signal by using an uplink shared channel and/or an uplink control channel, and an allocation position of the UL signal and/or an allocation position of a reference signal used for demodulation of the DL signal are controlled based on a time unit to be applied to the scheduling.

### TECHNICAL FIELD

The present invention relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of wider bands and a higher speed than those of LTE, LTE successor systems (that are also referred to as, for example, LTE Advanced (LTE-A), Future Radio Access (FRA), 4G, 5G, 5G+(plus), New Radio Access Technology (NR: New RAT) and LTE Rel. 14 and 15-) have been also studied.

Legacy LTE systems (e.g., LTE Rel. 13 or prior releases) perform communication on Downlink (DL) and/or Uplink (UL) by using Transmission Time Intervals (TTIs) (also referred to as a subframe) of 1 ms. This TTI of 1 ms is a transmission time unit of one channel-coded data packet, and is a processing unit of scheduling, link adaptation and retransmission control (HARQ-ACK: Hybrid Automatic Repeat reQuest-Acknowledge). The TTI of 1 ms includes 2 slots.

Furthermore, in the legacy LTE systems, a radio base station demodulates a UL channel (including a UL data channel (e.g., PUSCH: Physical Uplink Shared Channel) and/or a UL control channel (e.g., PUCCH: Physical Uplink Control Channel)) based on a channel estimation result of a Demodulation Reference Signal (DMRS). Furthermore, a user terminal demodulates a DL channel (DL data channel (e.g., PDSCH: Physical Downlink Shared Channel)) based on the channel estimation result of the Demodulation Reference Signal (DMRS).

Furthermore, in the legacy LTE systems (e.g., LTE Rel. 8 to 13), the user terminal transmits Uplink Control Information (UCI) by using a UL data channel (e.g., PUSCH) and/or a UL control channel (e.g., PUCCH). Transmission of the UCI is controlled based on whether or not simultaneous PUSCH and PUCCH transmission is configured and whether or not the PUSCH is scheduled in a TTI for transmitting the UCI.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

It has been studied for future radio communication systems (e.g., LTE Rel. 14 or 15, 5G and NR) to introduce a time units (e.g., TTIs (also referred to as a reduced TTI, a short TTI, an sTTI, a slot and a mini slot) shorter than a TTI of 1 ms) having different time durations from a time unit (also referred to as a subframe or a TTI) of 1 ms in the legacy LTE systems.

It is assumed that, as the time units different from those of the legacy LTE systems are introduced, transmission and reception (or allocation) of signals are controlled by applying a plurality of time units to scheduling of, for example, data. However, when, for example, data is scheduled by using a different time unit, there are plurality of data transmission durations and/or transmission timings. In this case, a problem is how to control transmission and reception of data and/or a transmission acknowledgement signal (also referred to as HARQ-ACK, ACK/NACK and A/N) for the data.

The present invention has been made in light of this point, and one of objects of the present invention is to provide a user terminal and a radio communication method that can appropriately perform communication even when scheduling based on a plurality of time units is supported in a radio communication system.

### Solution to Problem

One aspect of a user terminal according to the present invention includes: a control section that controls reception of a DL signal and/or transmission of a UL signal to be scheduled by applying at least one of a first time unit and a second time unit shorter than the first time unit; and a transmission section that transmits the UL signal by using an uplink shared channel and/or an uplink control channel, and an allocation position of the UL signal and/or an allocation position of a reference signal used for demodulation of the DL signal are controlled based on a time unit to be applied to the scheduling.

### Advantageous Effects of Invention

According to the present invention, it is possible to appropriately perform communication even when scheduling based on a plurality of time units is supported in a radio communication system.

### BRIEF DESCRIPTION OF DRAWINGS

FIGS. 1A and 1B are diagrams illustrating an arrangement example of a downlink DMRS and one example of a PDSCH mapping method according to a first aspect.

FIGS. 2A and 2B are diagrams illustrating an arrangement example of an uplink DMRS and one example of a PUSCH mapping method according to the first aspect.

FIGS. 3A and 3B are diagrams illustrating one example of a short PUCCH and a long PUCCH.

FIGS. 4A and 4B are diagrams illustrating one example of a transmission method of UCI in a case where scheduling is performed in slot units.

FIG. 5 is a diagram illustrating one example of a transmission method of a PUSCH and UCI in an identical slot.

FIGS. 6A and 6B are diagrams illustrating another example of the transmission method of the PUSCH and the UCI in the identical slot.

FIGS. 7A and 7B are diagrams illustrating one example of a mapping method according to the first aspect.

FIGS. 8A and 8B are diagrams illustrating another example of the mapping method according to the first aspect.

FIGS. 9A and 9B are diagrams illustrating another example of the mapping method according to the first aspect.

FIGS. 10A and 10B are diagrams illustrating one example of a transmission method of UCI in a case where scheduling is performed in a unit shorter than a slot.

FIG. 11 is a diagram illustrating one example of a schematic configuration of a radio communication system according to the present embodiment.

FIG. 12 is a diagram illustrating one example of an overall configuration of a radio base station according to the present embodiment.

FIG. 13 is a diagram illustrating one example of a function configuration of the radio base station according to the present embodiment.

FIG. 14 is a diagram illustrating one example of an overall configuration of a user terminal according to the present embodiment.

FIG. 15 is a diagram illustrating one example of a function configuration of the user terminal according to the present embodiment.

FIG. 16 is a diagram illustrating one example of hardware configurations of the radio base station and the user terminal according to the present embodiment.

### DESCRIPTION OF EMBODIMENTS

It has been studied for future radio communication systems (e.g., LTE Rel. 14 and 15-, 5G and NR) to introduce a plurality of numerologies (e.g., a subcarrier-spacing and/or a symbol length) instead of a single numerology. For example, the future radio communication systems may support a plurality of subcarrier-spacings such as 15 kHz, 30 kHz, 60 kHz and 120 kHz.

Furthermore, it has been studied for the future radio communication systems to introduce identical and/or different time units (also referred to as, for example, subframes, slots, mini slots, subslots, TT's or radio frames) to and/or from those of legacy LTE systems (LTE Rel. 13 or prior releases) as a plurality of numerologies are supported.

For example, the subframe is a time unit having a given time duration (e.g., 1 ms) irrespectively of numerologies applied by a user terminal.

On the other hand, the slot is a time unit based on the numerologies applied by the user terminal. When, for example, the subcarrier-spacing is 15 kHz or 30 kHz, the number of symbols per slot may be 7 or 14 symbols. On the other hand, when the subcarrier-spacing is 60 kHz or more, the number of symbols per slot may be 14 symbols. Furthermore, the slot may include a plurality of mini (sub) slots.

Generally, the subcarrier-spacing and a symbol length have a relationship of a reciprocal. Hence, when the number of symbols per slot (or mini (sub) slot) is identical, as the subcarrier-spacing is higher (wider), the slot length is shorter, and, as the subcarrier-spacing is lower (narrower), the slot length is longer.

The future radio communication systems are assumed to control transmission and reception (allocation) of a signal and/or a channel by applying a plurality of time units to scheduling of, for example, data as different time units from those of the legacy LTE systems are introduced. It is considered that, when scheduling of, for example, data is performed by using the different time units, there are pluralities of data transmission durations and/or transmission timings. For example, the user terminal that supports a plurality of time units transmits and receives data to be scheduled in the different time units.

In one example, it is considered to apply scheduling (slot-based scheduling) in a first time unit (e.g., a slot unit), and scheduling (non-slot-based scheduling) in a second time unit (e.g., a mini slot unit or a symbol unit) shorter than the first time unit. In addition, the slot can include, for example, 7 symbols or 14 symbols, and the mini slot can include 1 symbol, 2 symbols or 3 symbols. Naturally, the number of symbols is not limited to these.

In this case, according to a data (e.g., a PDSCH or a PUSCH) scheduling unit, an allocation position (e.g., start position) and an allocation duration of data in a time direction differ. When scheduling is performed in the slot unit, one data is allocated to 1 slot. On the other hand, when scheduling is performed in the mini slot unit (or the symbol unit), data is selectively allocated to part of a domain of 1 slot. Consequently, when scheduling is performed in the mini slot unit (or the symbol unit), a plurality of items of data can be allocated to 1 slot.

Generally, when data is transmitted, a reference signal (e.g., DMRS) used for demodulation of the data also needs to be transmitted. The legacy LTE systems perform scheduling in a subframe unit, and therefore fixedly define a data allocation domain and a DMRS allocation position (e.g., a position in the time direction). However, when scheduling is performed by applying a plurality of time units, a data domain to be scheduled changes, and therefore a problem is how to control allocation of the DMRS.

Furthermore, when data is transmitted, a transmission acknowledgement signal (also referred to as HARQ-ACK, ACK/NACK or A/N) for data needs to be transmitted to control retransmission of the data. The legacy LTE systems fixedly define a transmission position (allocation position) and a transmission duration of the transmission acknowledgement signal for the data (e.g., PUSCH). However, when a plurality of scheduling units are applied, a problem is how to control an allocation position and/or a transmission duration (position/duration) of the transmission acknowledgement signal.

Therefore, the inventors of this application have focused on that a data allocation position changes according to a time unit to be applied to scheduling on UL and/or DL, and conceived controlling at least one of a DMRS allocation position and allocation of HARQ-ACK based on the time unit to be applied to scheduling.

The DMRS allocation position may be a position to which the DMRS is allocated at least first in the time direction of a data (e.g., PDSCH or PUSCH) allocation domain, or may be the number of positions (e.g., the number of symbols to be allocated) at which the DMRS is allocated. The HARQ-ACK may be allocated to a position (time and/or frequency positions) to which the HARQ-ACK is allocated in a given time interval (e.g., slot), or may be allocated in a duration during which HARQ-ACK is allocated (a duration from data reception to HARQ-ACK transmission and/or a duration during which the HARQ-ACK is transmitted).

An embodiment according to the present invention will be described in detail below with reference to the drawings. Each radio communication method according to each embodiment may be each applied alone or may be applied in combination. In addition, the following description will describe a case where 1 slot includes 14 symbols. However, 1 slot is not limited to this, and may include another number of symbols (e.g., 7 symbols).

Furthermore, the following description will describe the first time unit (e.g., the slot unit) and the second time unit (the mini slot unit or the symbol unit) shorter than the first time unit as an example of time units to be applied to a processing procedure (e.g., scheduling). However, time units and types to be applied to the processing procedure are not limited to these.

### (First Aspect)

The first aspect will describe DMRS arrangement, data mapping and HARQ-ACK feedback in a case where processing in a slot unit (slot-level processing) is performed.

When data (e.g., a PDSCH and/or a PUSCH) is scheduled in the slot unit, data is allocated to a given position of the slot. Hence, a position of the DMRS used for demodulation of the data is fixedly configured.

### <DL Transmission>

According to DL transmission, a DMRS used for demodulation of DL data (PDSCH) is allocated to a given symbol of a slot. For example, the DMRS for PDSCH demodulation is allocated to a third symbol or a fourth symbol of the slot. In addition, the DMRS to be allocated to the third symbol or the fourth symbol only needs to be a DMRS that is allocated first in a time direction among DMRSs to be allocated for PDSCH demodulation, and the DMRS may be further allocated to subsequent symbols.

When the PDSCH is allocated in the slot unit, downlink control information (or a PDCCH) for scheduling the PDSCH may be allocated to a slot head. In this case, the downlink control information is allocated only to the slot head (1 symbol) or to several symbols (e.g., 2 or 3 symbols) from the head. In this case, an arrangement position of the DMRS for PDSCH demodulation may be changed according to a downlink control information arrangement position.

When, for example, the downlink control information is allocated up to the second symbol, the DMRS is arranged on the third symbol. When the downlink control information is allocated up to the third symbol, the DMRS is arranged on the fourth symbol. When the downlink control information is allocated up to the second symbol, and the DMRS is arranged on the third symbol, the DMRS is arranged on the first symbol on which the PDSCH is scheduled. Thus, when the DMRS is arranged on a first half part (e.g., the head or the second symbol) of a PDSCH allocation domain, a user terminal can quickly receive the DMRS and estimate a channel, so that it is possible to prevent delay of reception processing.

The user terminal may receive information related to the DMRS arrangement position, or may receive information related to a downlink control information arrangement position and/or a PDSCH start position, and decide the DMRS arrangement position. Alternatively, irrespectively of the downlink control information arrangement position, the position of the DMRS for PDSCH demodulation may be fixedly configured.

As a DL data (PDSCH) mapping method, frequency-first mapping or time-first mapping may be applied. Frequency-first mapping refers to a method for mapping data first in a frequency direction (and then mapping the data in the time direction). Time-first mapping refers to a method for mapping data first in the time direction (and then mapping the data in the frequency direction).

In addition, time-first mapping may be realized by causing an interleaver including the number of time resources×the number of frequency resources on which the data symbol sequence is mapped to apply interleaving to a data symbol sequence generated assuming frequency-first mapping.

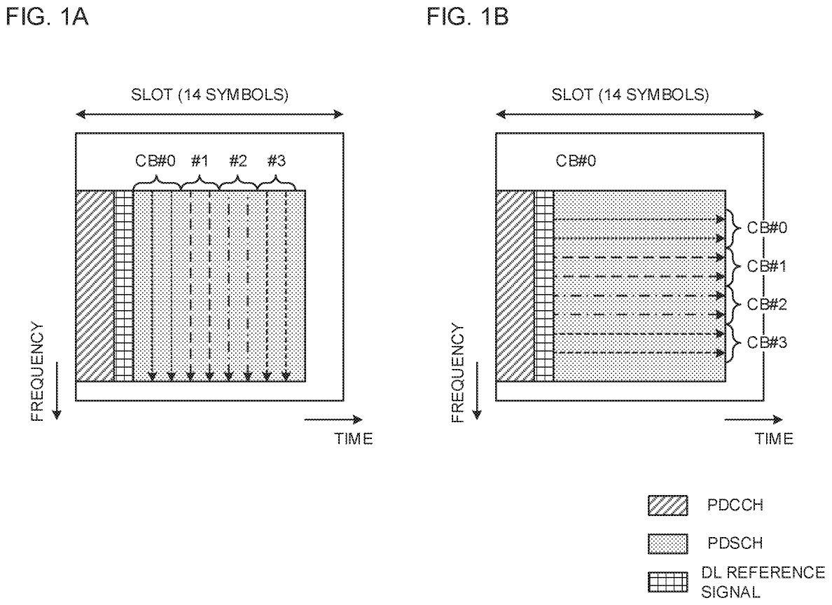

FIG. 1A illustrates a case where frequency-first mapping is applied to PDSCH transmission. FIG. 1B illustrates a case where time-first mapping is applied to PDSCH transmission. In addition, FIG. 1 illustrates a case where mapping is performed in a CB unit (CB mapping). However, a DL signal transmission unit is not limited to the CB, and may be other units (e.g., a CW unit or a Code Block Group (CBG) unit).

Furthermore, when DL transmission is performed by using a plurality of layers, a mapping order of frequency-first mapping may be layer-frequency-time or may be frequency-layer-time. That is, mapping may be carried out in the frequency direction at least preferentially over the time direction. Furthermore, when DL transmission is performed by using a plurality of layers, the mapping order of time-first mapping may be layer-time-frequency or may be time-layer-frequency. That is, mapping only needs to be carried out in the time direction at least preferentially over the frequency direction.

### <UL Transmission>

According to UL transmission, a DMRS used for demodulation of a UL signal (a PUSCH and/or a PUCCH) is allocated to a given symbol in a PUSCH allocation domain. The given symbol may be a head symbol (start symbol) in a time-domain in which UL data is scheduled (allocated). In addition, the DMRS to be allocated to the start symbol for PUSCH allocation only needs to be a DMRS that is allocated first in the time direction among DMRSs for PUSCH demodulation, and the DMRS may be further allocated to subsequent symbols.

When the DMRS is arranged in at least a start part (e.g., head symbol) of the PUSCH allocation domain, a radio base station can quickly receive the DMRS and estimate a channel, so that it is possible to prevent delay of reception processing. Alternatively, the DMRS for UL signal (PUSCH and/or PUCCH) demodulation may be allocated to a given symbol (e.g., a third symbol or a fourth symbol of a slot) of the slot.

As a UL data (PUSCH) mapping method, frequency-first mapping or time-first mapping may be applied.

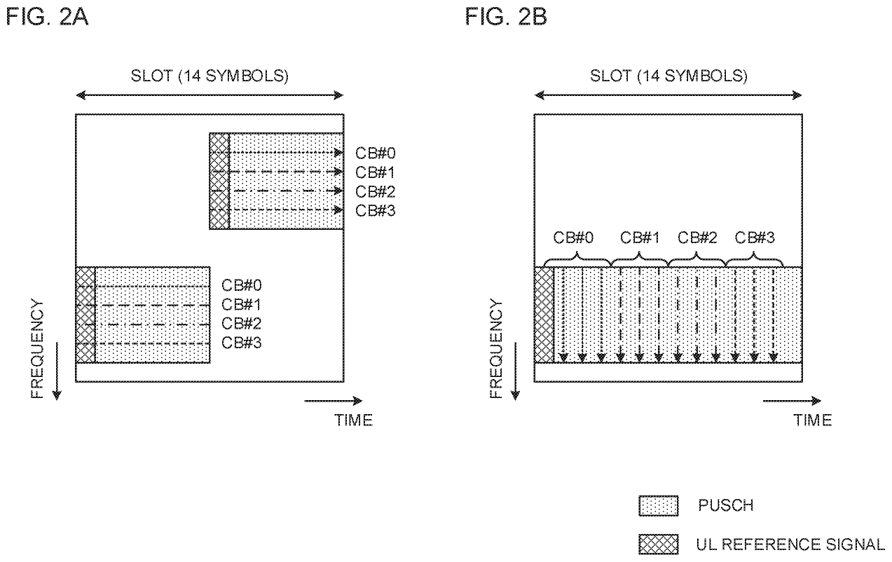

FIG. 2A illustrates a case where, during PUSCH transmission, time-first mapping is applied to the UL signal (e.g., UL data) that is transmitted in a given unit. Furthermore, FIG. 2A illustrates a case where frequency hopping (intra-slot FH) is applied within a range of a given time unit (a slot in this case), and a PUSCH is allocated to a first frequency domain and a second frequency domain. FIG. 2B illustrates a case where, during PUSCH transmission, frequency-first mapping is applied to the UL signal (e.g., UL data) that is transmitted in the given unit.

In addition, FIG. 2 illustrates a case where mapping is performed in the CB unit (CB mapping).

A UL signal transmission unit is not limited to the CB, and may be other units (e.g., the CW unit or the Code Block Group (CBG) unit).

Time-first mapping may repeat processing of arranging all data symbols to be transmitted on a corresponding channel, mapping the data symbols in a symbol direction of a certain subcarrier (RE), incrementing a subcarrier (RE) index when the data symbols reach the end of the channel, and mapping the data symbols in the symbol direction. In this case, mapping is performed in a data symbol unit, so that it is possible to perform time-first mapping irrespectively of a CB length or a CW length. In addition, the Code Block Group (CBG) refers to a group including one or more CBs.

When time-first mapping is applied, each CB is mapped first in the time direction and then in the frequency direction (time-first frequency-second). Hence, the user terminal maps each CB first in the time direction (e.g., over different symbols). Thus, each CB (CBs #0 to #3 in this case) is mapped both in the first frequency domain and the second frequency domain to which frequency hopping is applied. As a result, each CB is distributed and arranged in the frequency direction, so that it is possible to obtain a frequency diversity gain.

FIG. 2A illustrates a case where 1 slot including 14 symbols is divided every 7 symbols and is applied frequency hopping (intra-slot FH), yet is not limited to this. For example, the 1 slot may be divided (frequency hopping unit) into 9 symbols and 5 symbols, or three or more different frequency domains may be configured in 1 slot and frequency hopping may be applied. Furthermore, a reference signal may be arranged in each domain to be divided in the frequency direction. In addition, frequency hopping division control may differ between temporarily different slots.

The user terminal may determine the mapping method according to a waveform to be applied to transmission of a UL shared channel and whether or not frequency hopping is applied. When, for example, applying both of a DFT-spread-OFDM waveform (single carrier waveform) and frequency hopping, the user terminal selects time-first mapping for performing mapping first in the time direction (see FIG. 2A). On the other hand, in the other cases, the user terminal may select frequency-first mapping for performing mapping first in the frequency direction (see FIG. 2B).

In this case, when the DFT-spread-OFDM waveform (single carrier waveform) is applied yet frequency hopping is not applied, it is possible to map a UL signal (e.g., each CB) in the frequency direction in one or a plurality of contiguous RBs (see FIG. 2B). Consequently, even when a UL shared channel is transmitted without applying frequency hopping to the DFT-spread-OFDM waveform, it is possible to distribute the UL signal in the frequency direction (in the one or contiguous RBs) to some degree. Furthermore, a decoding start time of each CB can be shifted, so that it is possible to easily enable multistage structuring and serialization of a circuit configuration and baseband processing.

### <HARQ-ACK Feedback>

The user terminal transmits a transmission acknowledgement signal for DL data (PDSCH) by using an uplink control channel and/or an uplink shared channel.

The future radio communication systems are assumed to support a UL control channel (also referred to as a short PUCCH below) including a shorter duration than that of a PUCCH format of the legacy LTE systems (e.g., LTE Rel. 13 or prior releases) and/or a UL control channel (also referred to as a long PUCCH below) including a longer duration than this short duration.

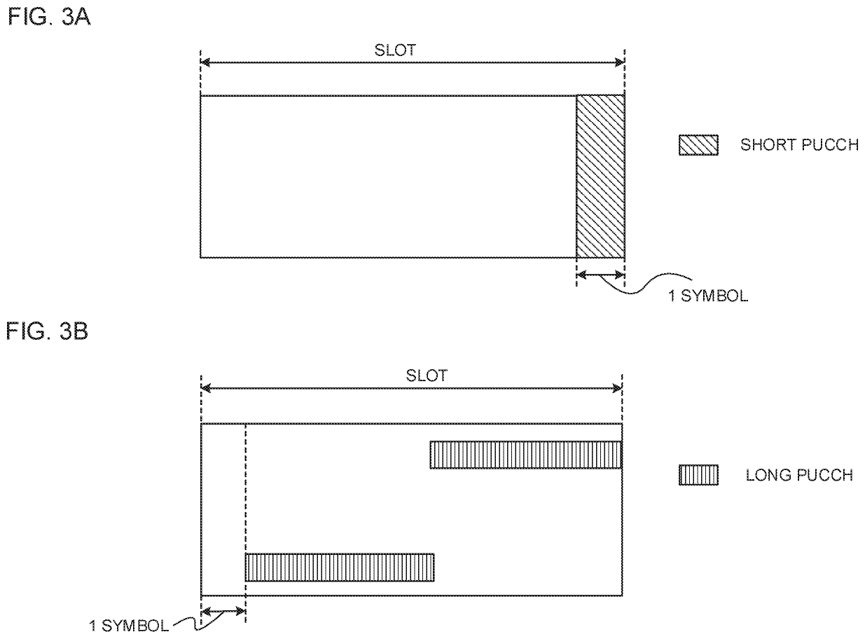

FIG. 3 is a diagram illustrating a configuration example of the UL control channels of the future radio communication system. FIG. 3A illustrates one example of the short PUCCH at a given time interval (a slot in this case), and FIG. 3B illustrates one example of the long PUCCH. As illustrated in FIG. 3A, the short PUCCH is arranged on a given number of symbols (1 symbol in this case) from the end of a slot. In this regard, arrangement symbols of the short PUCCH are not limited to the end of the slot, and may be a given number of symbols at the head or the middle of the slot. Furthermore, the short PUCCH is arranged on one or more frequency resources (e.g., one or more Physical Resource Blocks (PRBs)).

For the short PUCCH, a multicarrier waveform (e.g., Orthogonal Frequency Division Multiplexing (OFDM) waveform) may be used, or a single carrier waveform (e.g., Discrete Fourier Transform-Spread-Orthogonal Frequency Division Multiplexing (DFT-s-OFDM) waveform) may be used.

On the other hand, as illustrated in FIG. 3B, the long PUCCH is arranged over a plurality of symbols in the slot to improve a coverage compared to the short PUCCH. In FIG. 3B, the long PUCCH is not arranged on a given number of first symbols (1 symbol in this case) of the slot, yet may be arranged over a plurality of symbols including the given number of first symbols. Furthermore, the long PUCCH may include a smaller number of frequency resources (e.g., one or two PRBs) than that of the short PUCCH to obtain a power boosting effect.

Furthermore, the long PUCCH may be subjected to frequency division multiplexing with a PUSCH in the slot. Furthermore, the long PUCCH may be subjected to time division multiplexing with the PDCCH in the slot. Furthermore, as illustrated in FIG. 3B, frequency hopping may be applied to the long PUCCH per given duration (e.g., mini (sub) slot) in the slot. The long PUCCH may be arranged in a slot identical to that of the short PUCCH. For the long PUCCH, the single carrier waveform (e.g., DFT-s-OFDM waveform) may be used.

When scheduling (e.g., scheduling on UL and/or DL) is controlled in the slot unit, HARQ-ACK feedback for the PDSCH may be configured to be performed by using a given position and/or duration. That is, a position and/or a duration of HARQ-ACK feedback may be restricted. In this case, one or a plurality of positions and/or durations of HARQ-ACK feedback may be defined in advance.

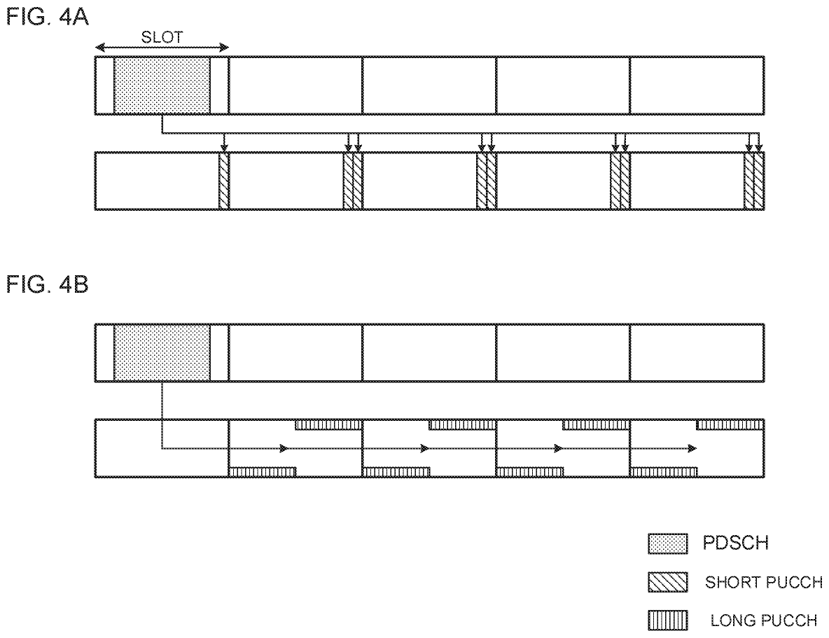

When, for example, feeding back HARQ-ACK by using the short PUCCH, the user terminal uses the short PUCCH configured to given symbols of a given slot (see FIG. 4A). The given slot may be a range to a slot within a given duration from a slot in which the PDSCH is transmitted. Furthermore, the given symbols may be a last symbol of the slot, a symbol that is several symbols before the last symbol or a plurality of symbols including the last symbol.

Furthermore, when feeding back HARQ-ACK by using the long PUCCH, the user terminal uses the long PUCCH configured to a given slot (see FIG. 4B). The given slot may be fixedly configured within a range to a slot within a given duration from a next slot of the slot in which the PDSCH is transmitted. HARQ-ACK may be fed back in a slot that is the given duration after the slot in which the PDSCH is transmitted, or the slot within the given duration from the slot in which the PDSCH is transmitted may be instructed to the user terminal by downlink control information.

Information related to the position and/or the duration of the short PUCCH or the long PUCCH applied by the user terminal may be notified by using the downlink control information or may be defined in advance and autonomously decided by the user terminal. In addition, the user terminal may transmit uplink control information by using both of the short PUCCH and the long PUCCH in the same slot or may transmit the uplink control information by using one of the short PUCCH and the long PUCCH.

Thus, when scheduling is controlled in the slot unit, it is possible to fixedly configure a slot configuration (PUCCH position) and control transmission and reception of a signal by restricting HARQ-ACK to a given position and/or duration and scheduling the HARQ-ACK. Furthermore, it is easy to adjust symbol positions of the PUCCH between neighboring cells, so that it is possible to limit a signal that interferes with the PUCCH to the PUCCH and prevent an inter-cell interference.

### <UCI Mapping Method>

Furthermore, when a PUSCH is scheduled in a slot in which uplink control information (e.g., HARQ-ACK) is transmitted by using a PUCCH, multiplexing (mapping) of the uplink control information may be controlled based on a PUCCH type (PUCCH configuration). Hereinafter, mapping of the uplink control information in cases where a PUCCH configuration is a short PUCCH and is a long PUCCH will be described.

### [Short PUCCH]

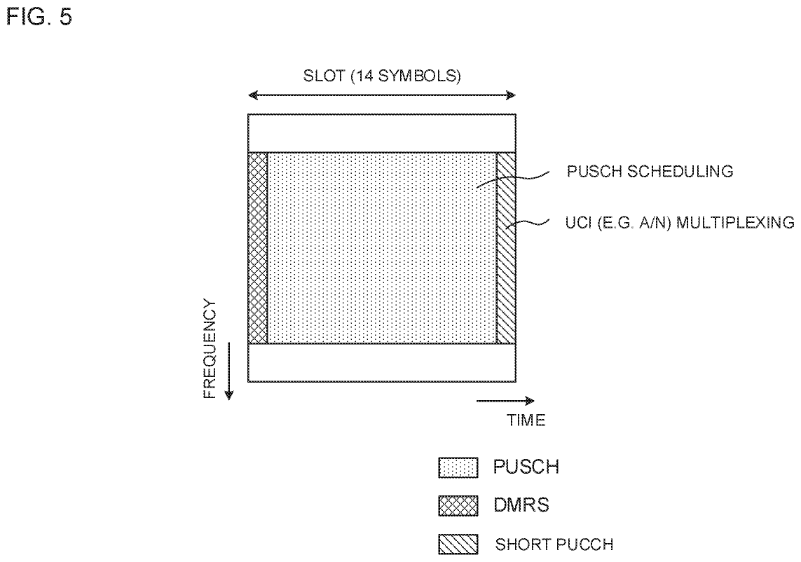

When HARQ-ACK transmission that uses a short PUCCH to which an end portion (e.g., last symbol) of a slot is performed in the slot in which a PUSCH is scheduled, the HARQ-ACK is transmitted by using the short PUCCH (see FIG. 5). In this case, the user terminal transmits UL data by using the PUSCH, and transmits the HARQ-ACK by using the short PUCCH.

In this case, a PUSCH allocation domain may be configured short to transmit the short PUCCH. For example, the PUSCH is configured not to be allocated to an end portion (e.g., the last symbol or several symbols including the last symbol) of the slot to which the short PUCCH is configured. Thus, by time-multiplexing the PUSCH and the short PUCCH and transmitting data and HARQ-ACK by using the respective channels, it is possible to apply a UL channel suitable to each signal and transmit each signal. Furthermore, by time-multiplexing and transmitting the PUSCH and the short PUCCH, it is possible to transmit each signal by using a single carrier waveform.

### [Long PUCCH]

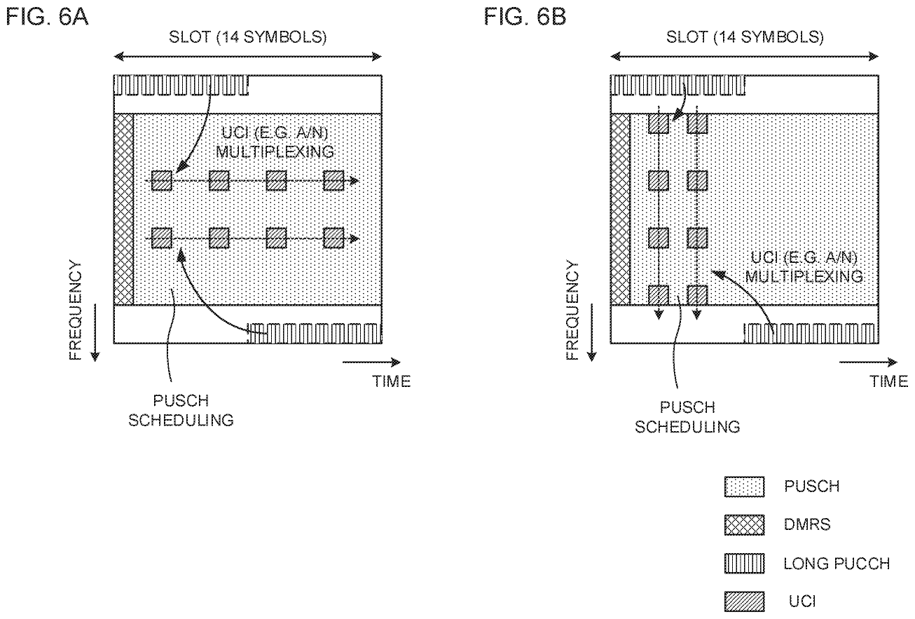

When HARQ-ACK transmission that uses the long PUCCH to be allocated over a slot is performed in the slot in which a PUSCH is scheduled, the HARQ-ACK may be multiplexed with the PUSCH and transmitted (see FIG. 6). In this case, the user terminal transmits UL data and the HARQ-ACK by using the PUSCH (UCI on PUSCH).

When UCI (e.g., HARQ-ACK) is mapped on a UL shared channel, the UCI is distributed and mapped. The user terminal may apply time-first mapping or frequency-first mapping as a UCI mapping method. FIG. 6A illustrates a case where time-first mapping is applied to the UCI, and FIG. 6B illustrates a case where frequency-first mapping is applied to the UCI.

There may be employed a configuration where the number of symbols and/or symbol positions on which the UCI is mapped can be flexibly configured in the time-domain to which the PUSCH is allocated. Consequently, it is possible to perform control to increase the number of symbols when the number of bits of the UCI is large, and to decrease the number of symbols when the number of bits of the UCI is small (or when latency is reduced) and arrange the symbol positions at the first half of the time direction.

Furthermore, the user terminal may distribute and arrange the UCI in a direction identical to or different from a mapping (e.g., CB mapping) direction of UL data. In addition, when multiplexing the UCI with the PUSCH, the user terminal only needs to perform puncturing processing on a given PUSCH resource (e.g., an RE of the PUSCH).

For example, the user terminal can use one of a configuration (mapping configuration 1) where a mapping method (a direction in which mapping is performed first) to be applied to UL data and a mapping method (the direction in which mapping is performed first) to be applied to UCI are different, a configuration (mapping configuration 2) where the first mapping direction of the UL data and a direction in which the UCI is distributed and arranged are the same, and a configuration (mapping configuration 3) that is a combination of the mapping configurations 1 and 2. Each mapping configuration will be described below.

### Mapping Configuration 1

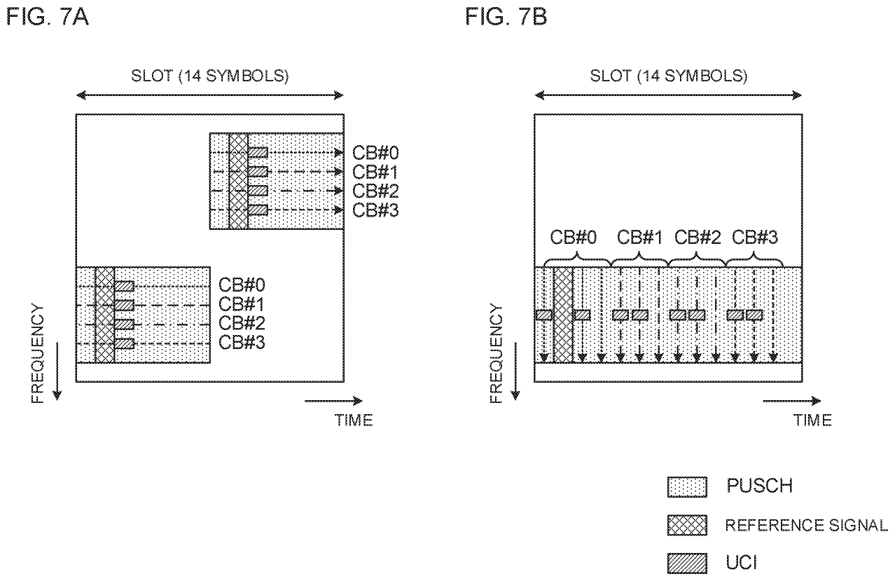

When mapping UL data first in the time direction, the user terminal maps UCI to distribute in the frequency direction (see FIG. 7A). That is, when time-first mapping is applied to mapping of the UL data (e.g., CB mapping), frequency-first mapping (freq-distributed mapping) is applied to mapping of the UCI. In addition, an interval of the UCI to be distributed does not necessarily need to be an equal interval. Consequently, it is possible to flexibly control a mapping position of the UCI by taking a mapping position of each CB into account. Furthermore, it is possible to average an influence due to UCI mapping per CB, and minimize throughput deterioration of each CB due to the UCI mapping.

Furthermore, when mapping UL data first in the frequency direction, the user terminal maps UCI to distribute in the time direction (see FIG. 7B). That is, when frequency-first mapping is applied to mapping of UL data, time-first mapping (time-distributed mapping) is applied to mapping of the UCI. In addition, the interval of the UCI to be distributed does not necessarily need to be an equal interval. Consequently, it is possible to flexibly control the mapping position of the UCI by taking the mapping position of each CB into account. Furthermore, it is possible to average the influence due to the UCI mapping per CB, and minimize throughput deterioration of each CB due to the UCI mapping.

According to the mapping configuration 1, the UCI is distributed and arranged in a domain in which each UL data (e.g., each CB) is mapped. In, for example, FIG. 7A, by distributing and arranging the UCI in the frequency direction, it is possible to arrange the UCI on a resource of each of the CBs #0 to #3 that are mapped in the time direction. In FIG. 7B, by distributing and arranging the UCI in the time direction, it is possible to arrange the UCI on the resource of each of the CBs #0 to #3 that are mapped in the frequency direction.

According to this configuration, it is possible to distribute a PUSCH resource to be punctured by the UCI to the resource of each CB, and consequently distribute (or average) an influence of puncturing without concentrating the influence on a specific CB. As a result, it is possible to prevent an increase of an error rate of the specific CB, and prevent deterioration of communication quality.

### Mapping Configuration 2

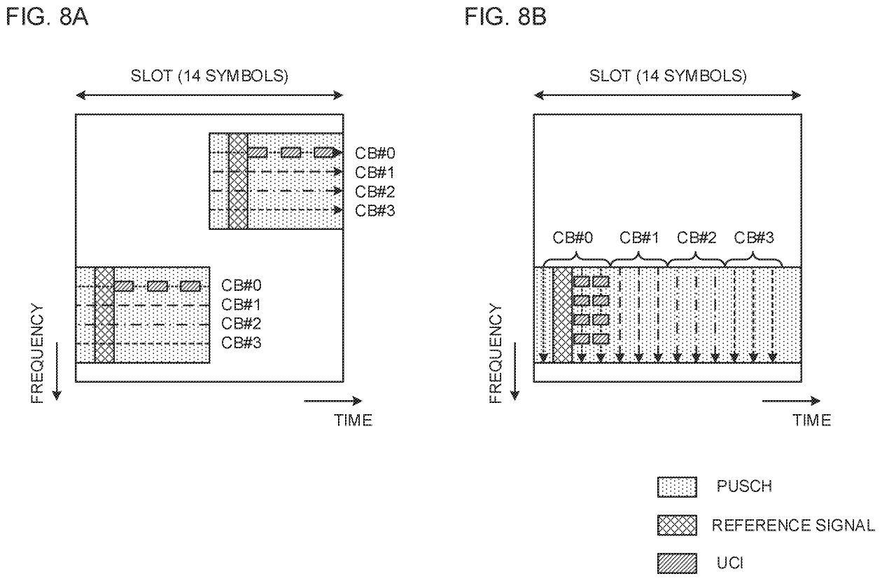

When mapping UL data first in the time direction, the user terminal maps UCI to distribute in the time direction, too (see FIG. 8A). That is, when time-first mapping is applied to mapping of the UL data, time-first mapping is applied to mapping of the UCI. In addition, an interval of the UCI to be distributed does not necessarily need to be an equal interval.

Furthermore, when mapping UL data first in the frequency direction, the user terminal maps the UCI to distribute in the frequency direction, too (see FIG. 8B). That is, when frequency-first mapping is applied to mapping of the UL data, frequency-first mapping is applied to mapping of the UCI. In addition, an interval of the UCI to be distributed does not necessarily need to be an equal interval.

According to the mapping configuration 2, the UCI is arranged in a domain in which specific UL data (e.g., specific CB) is mapped. In, for example, FIG. 8A, by distributing and arranging the UCI in the time direction, it is possible to concentrate and arrange the UCI on a resource of a specific CB (the CB #0 in this case) that is mapped in the time direction. In FIG. 8B, by distributing and arranging the UCI in the frequency direction, it is possible to concentrate and arrange the UCI on a resource of a specific CB (the CB #0 in this case) that is mapped in the frequency direction.

According to this configuration, it is possible to concentrate a PUSCH resource to be punctured by the UCI on the resource of the specific CB. The specific CB (e.g., the CB #0 in FIG. 8) is considered to increase a probability (e.g., error rate) that the radio base station fails reception compared to the other CBs (the CBs #1 to #3 in FIG. 8).

Hence, according to the mapping configuration 2, it is desirable to support HARQ-ACK feedback matching UL data in the CB unit or the CBG unit (on a CB basis or a CBG basis). Consequently, it is possible to selectively retransmit the specific CB (or a CGB including the specific CB) and consequently prevent an increase of an overhead due to the retransmission. As a result, it is possible to make it unnecessary to retransmit an overall TB including the specific CB, and prevent a decrease of a throughput.

### Mapping Configuration 3

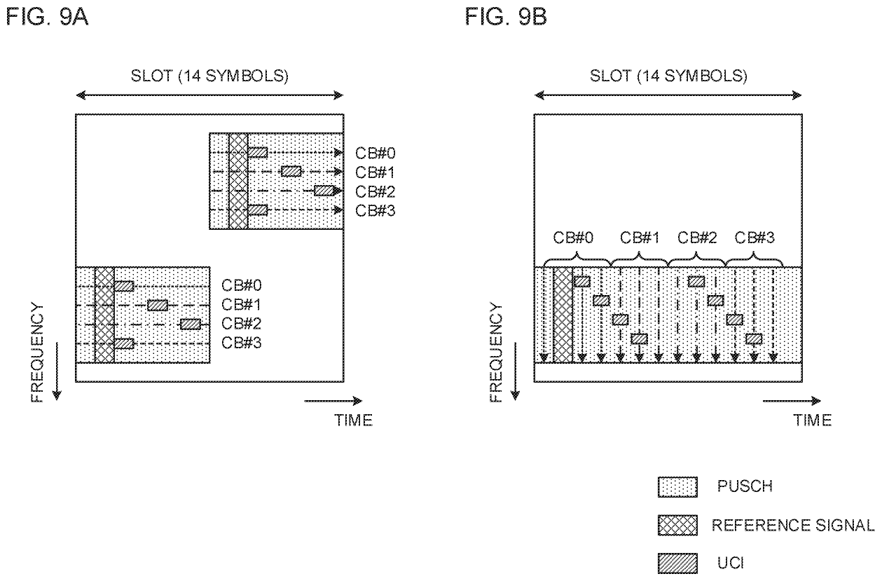

The user terminal may distribute and map UCI in the time direction and the frequency direction irrespectively of a direction in which UL data is mapped first. When, for example, mapping the UL data first in the time direction, the user terminal may map the UCI to distribute in the frequency direction and the time direction (see FIG. 9A). Furthermore, when mapping UL data first in the frequency direction, the user terminal may map the UCI to distribute in the frequency direction and the time direction (see FIG. 9B).

Consequently, it is possible to distribute a PUSCH resource to be punctured by the UCI to a resource of each CB and consequently distribute (or average) an influence of puncturing without concentrating the influence on a specific CB. As a result, it is possible to prevent an increase of an error rate of the specific CB and prevent deterioration of communication quality. Furthermore, it is possible to distribute the PUSCH resource to be punctured by the UCI per CB in the time direction and/or the frequency direction. Consequently, it is possible to average an influence that the puncturing by the UCI has on each CB, and consequently avoid a case where an error rate of only the specific CB deteriorates.

### Modified Example

In addition, the case where the user terminal selects mapping directions of UL data and UCI based on given conditions has been described above. However, information related to the mapping direction (time-first mapping or frequency-first mapping) applied by the user terminal may be instructed from the radio base station to the user terminal. For example, the radio base station notifies the user terminal of the information related to the mapping direction applied to the UL data and the UCI by using downlink control information and/or higher layer signaling.

Alternatively, the mapping directions applied by the user terminal may be decided based on both of an instruction from the radio base station to the user terminal and the given conditions. When, for example, frequency-first mapping is configured by higher layer signaling, the user terminal applies frequency-first mapping (+mapping of the UCI in the time direction or the frequency direction) irrespectively of whether or not frequency hopping is applied and a waveform. On the other hand, when application of time-first mapping is configured by higher layer signaling, the user terminal applies one of frequency-first mapping and time-first mapping according to whether or not frequency hopping is applied or the waveform.

### (Second Aspect)

The second aspect will describe DMRS arrangement, data mapping and HARQ-ACK feedback in a case where processing in a unit shorter than a slot is performed. The unit shorter than the slot includes a mini slot unit or a symbol unit including a smaller number of symbols (e.g., 1, 2 or 3 symbols) than symbols that compose the slot.

When data (e.g., a PDSCH and/or a PUSCH) is scheduled in the mini slot unit or the symbol unit, data is allocated to part of the time-domain of the slot. In this case, the time-domain to which the data is allocated in the slot changes according to scheduling of the data. For example, the data is allocated to part of the time-domain (e.g., 2 symbols) in the slot.

Hence, a position of a DMRS used for demodulation of the data is configured according to a position of the data to be scheduled instead of fixedly allocating the position of the DMRS to a specific symbol of the slot. In this case, according to DL transmission and UL transmission, the DMRS used for demodulation of the data (the PDSCH and/or the PUSCH) is allocated to a given symbol of a data allocation domain. The given symbol may be a head symbol (start symbol) in the time-domain in which the data is scheduled (allocated).

For example, an uplink DMRS to be allocated to the start symbol in the time-domain in which the PUSCH is scheduled only needs to be a DMRS that is allocated first in the time direction among DMRSs for PUSCH demodulation, and the DMRS may be further allocated to subsequent symbols. Similarly, a downlink DMRS to be allocated to the start symbol in the time-domain in which the PDSCH is scheduled only needs to be a DMRS that is allocated first in the time direction among DMRSs for PDSCH demodulation, and the DMRS may be further allocated to subsequent symbols.

By using a reference signal used for demodulation of the data as the head symbol of the data allocation domain, it is possible to arrange the data and the DMRS close to each other even when the data is allocated to part of the slot.

Furthermore, as a method for mapping data (the PDSCH and/or the PUSCH) scheduled in the unit shorter than the slot, frequency-first mapping or time-first mapping may be applied. The method described in the above first aspect may be applied as the data mapping method.

### <HARQ-ACK Feedback>

The user terminal transmits a transmission acknowledgement signal for DL data (PDSCH) to be transmitted in a unit (e.g., a mini slot unit or a symbol unit) different from a slot unit by using an uplink control channel and/or an uplink shared channel. The short PUCCH and/or the long PUCCH may be applied as the uplink control channels.

When scheduling (e.g., scheduling on UL and/or DL) is controlled in the mini slot unit or the symbol unit, a position and/or a duration of HARQ-ACK feedback for the PDSCH may be configured not to be restricted. In this case, the position and/or the duration of HARQ-ACK feedback may not be defined in advance and dynamically notified to the user terminal by using downlink control information. Consequently, the radio base station can flexibly control HARQ-ACK feedback for the PDSCH.

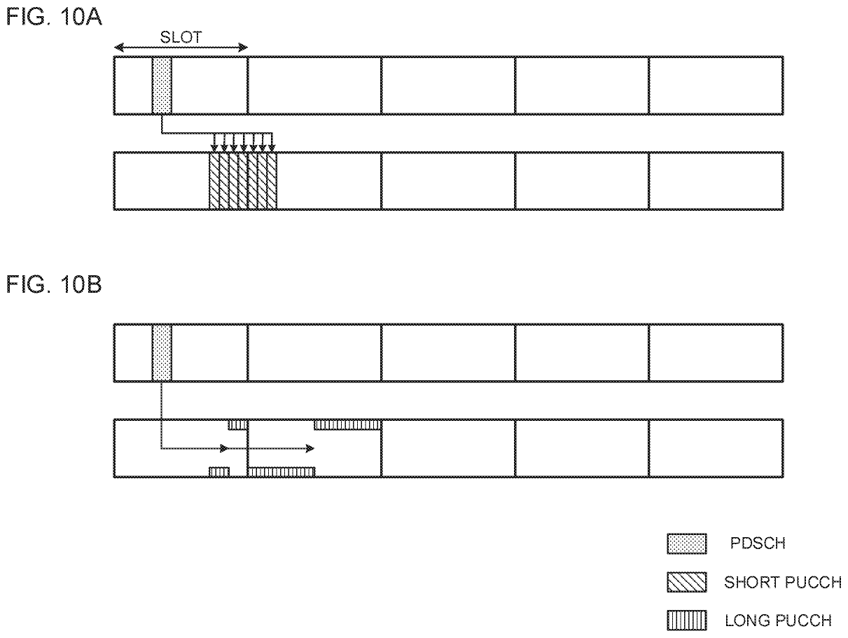

When, for example, feeding back HARQ-ACK by using the short PUCCH, the user terminal controls transmission of the HARQ-ACK based on information (e.g., information that indicates a given slot and/or a given symbol) notified by the downlink control information (see FIG. 10A). The user terminal can feed back the HARQ-ACK by using the short PUCCH that is not limited to an end portion of the slot (e.g., configured to one of symbols of the slot).

Thus, when scheduling is controlled in the mini slot unit or the symbol unit, it is possible to perform HARQ-ACK transmission that uses the short PUCCH at a middle part of the slot. Consequently, it is possible to flexibly configure a position and/or a transmission timing of the short PUCCH compared to a case where scheduling is performed in the slot unit (e.g., a configuration where the short PUCCH is configured to the slot end portion).

Furthermore, when feeding back HARQ-ACK by using the long PUCCH, the user terminal controls allocation of HARQ-ACK based on the information (e.g., information that indicates the given slot and/or the given symbol) notified by the downlink control information (see FIG. 10B).

When scheduling is controlled in the mini slot unit or the symbol unit, it is possible to perform HARQ-ACK transmission that uses the long PUCCH by using part of symbols of the slot. Consequently, it is possible to flexibly configure the long PUCCH compared to a case where scheduling is performed in the slot unit (a configuration where the long PUCCH is configured over a slot).

As described above, in the case where data (e.g., the PDSCH and/or the PUSCH) is scheduled in the slot unit and the case where the data (e.g., the PDSCH and/or the PUSCH) is scheduled in the mini slot unit or the symbol unit described in the first aspect and the second aspect, the user terminal may recognize which data the scheduled data is based on at least one of explicit signaling such as higher layer signaling or physical layer signaling that is, for example, DCI, and implicit information based on other configuration information and parameters.

The data scheduling type (in the slot unit or the mini slot/symbol unit) may be restricted to be the same between DL (PDSCH) and UL (PUSCH) on a certain carrier and a certain Bandwidth Part (BWP) or may be configured separately between DL and UL. When the data scheduling type is restricted to be the same between DL and UL, it is possible to simplify scheduling and HARQ control. When the data scheduling type can be configured separately between DL and UL, it is possible to perform more flexible scheduling and HARQ control.

### (Radio Communication System)

The configuration of the radio communication system according to the present embodiment will be described below. This radio communication system is applied the radio communication method according to each of the above aspects. In addition, the radio communication method according to each of the above aspects may be each applied alone or may be applied in combination.

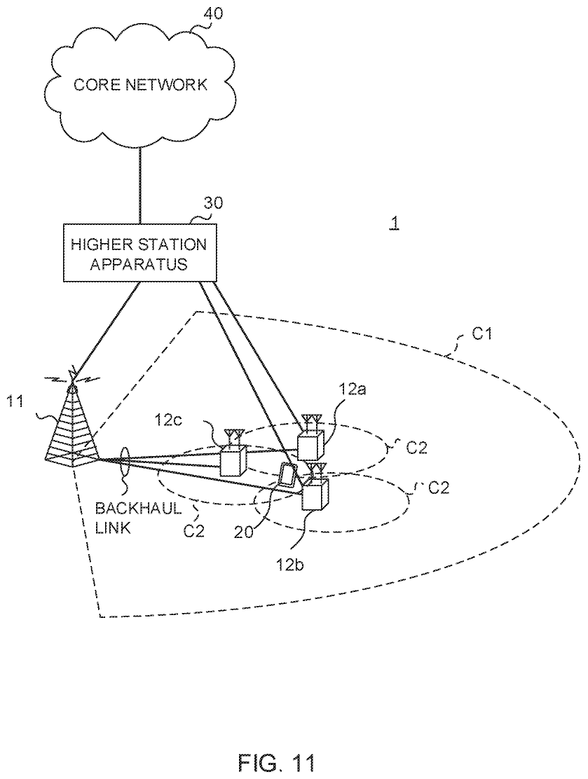

FIG. 11 is a diagram illustrating one example of a schematic configuration of the radio communication system according to the present embodiment. A radio communication system 1 can apply Carrier Aggregation (CA) and/or Dual Connectivity (DC) that aggregate a plurality of base frequency blocks (component carriers) whose 1 unit is a system bandwidth (e.g., 20 MHz) of the LTE system. In this regard, the radio communication system 1 may be referred to as SUPER 3G, LTE-Advanced (LTE-A), IMT-Advanced, 4G, 5G, Future Radio Access (FRA) or New-RAT (NR).

The radio communication system 1 illustrated in FIG. 11 includes a radio base station 11 that forms a macro cell C1, and radio base stations 12a to 12c that are located in the macro cell C1 and form small cells C2 narrower than the macro cell C1. Furthermore, a user terminal 20 is located in the macro cell C1 and each small cell C2. Different numerologies may be configured to be applied between cells. In this regard, the numerology refers to a communication parameter set that characterizes a signal design of a certain RAT and/or a RAT design.

The user terminal 20 can connect with both of the radio base station 11 and the radio base stations 12. The user terminal 20 is assumed to concurrently use the macro cell C1 and the small cells C2 that use different frequencies by CA or DC. Furthermore, the user terminal 20 can apply CA or DC by using a plurality of cells (CCs) (e.g., two or more CCs). Furthermore, the user terminal can use licensed band CCs and unlicensed band CCs as a plurality of cells.

Furthermore, the user terminal 20 can communicate by using Time Division Duplex (TDD) or Frequency Division Duplex (FDD) in each cell. A TDD cell and an FDD cell may be each referred to as a TDD carrier (frame configuration type 2) and an FDD carrier (frame configuration type 1).

Furthermore, in each cell (carrier), one of a subframe (also referred to as a TTI, a general TTI, a long TTI, a general sabframe, a long subframe or a slot) having a relatively long time duration (e.g., 1 ms) or a subframe (also referred to as a short TTI, a short subframe or a slot) having a relatively short time duration may be applied, or both of the long subframe and the short subframe may be applied. Furthermore, in each cell, a subframe of 2 or more time durations may be applied.

The user terminal 20 and the radio base station 11 can communicate by using a carrier (referred to as a Legacy carrier) of a narrow bandwidth in a relatively low frequency band (e.g., 2 GHz). On the other hand, the user terminal 20 and each radio base station 12 may use a carrier of a wide bandwidth in a relatively high frequency band (e.g., 3.5 GHz, 5 GHz or 30 to 70 GHz) or may use the same carrier as that used between the user terminal 20 and the radio base station 11. In this regard, a configuration of the frequency band used by each radio base station is not limited to this.

The radio base station 11 and each radio base station 12 (or the two radio base stations 12) can be configured to be connected by way of wired connection (e.g., optical fibers compliant with a Common Public Radio Interface (CPRI) or an X2 interface) or radio connection.

The radio base station 11 and each radio base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each radio base station 12 may be connected with the higher station apparatus 30 via the radio base station 11.

In this regard, the radio base station 11 is a radio base station that has a relatively wide coverage, and may be referred to as a macro base station, an aggregate node, an eNodeB (eNB) or a transmission/reception point. Furthermore, each radio base station 12 is a radio base station that has a local coverage, and may be referred to as a small base station, a micro base station, a pico base station, a femto base station, a Home eNodeB (HeNB), a Remote Radio Head (RRH) or a transmission/reception point. The radio base stations 11 and 12 will be collectively referred to as a radio base station 10 below when not distinguished.

Each user terminal 20 is a terminal that supports various communication schemes such as LTE and LTE-A, and may include not only a mobile communication terminal but also a fixed communication terminal. Furthermore, the user terminal 20 can perform Device-to-Device communication (D2D) with the other user terminal 20.

The radio communication system 1 applies Orthogonal Frequency-Division Multiple Access (OFDMA) to downlink (DL) and Single Carrier-Frequency Division Multiple Access (SC-FDMA) to uplink (UL) as radio access schemes. OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into a band including one or contiguous resource blocks per terminal and causes a plurality of terminals to use respectively different bands to reduce an inter-terminal interference. In this regard, uplink and downlink radio access schemes are not limited to a combination of these, and OFDMA may be used on UL. Furthermore, SC-FDMA is applicable to Sidelink (SL) used for device-to-device communication.

The radio communication system 1 uses a DL data channel (also referred to as a PDSCH: Physical Downlink Shared Channel or a DL shared channel) shared by each user terminal 20, a broadcast channel (PBCH: Physical Broadcast Channel) and an L1/L2 control channel as DL channels. At least one of user data, higher layer control information and System Information Blocks (SIBs) is conveyed on the PDSCH. Furthermore, Master Information Blocks (MIBs) are conveyed on the PBCH.

The L1/L2 control channel includes a DL control channel (e.g., a Physical Downlink Control Channel (PDCCH) and/or an Enhanced Physical Downlink Control Channel (EPDCCH)), a Physical Control Format Indicator Channel (PCFICH), and a Physical Hybrid-ARQ Indicator Channel (PHICH). Downlink Control Information (DCI) including scheduling information of the PDSCH and the PUSCH is conveyed on the PDCCH and/or the EPDCCH. The number of OFDM symbols used for the PDCCH is conveyed on the PCFICH. The EPDCCH is subjected to frequency division multiplexing with the PDSCH and is used to convey DCI similar to the PDCCH. Transmission acknowledgement information (A/N or HARQ-ACK) of the PUSCH can be conveyed on at least one of the PHICH, the PDCCH and the EPDCCH.

The radio communication system 1 uses a UL data channel (also referred to as a PUSCH: Physical Uplink Shared Channel or a UL shared channel) shared by each user terminal 20, a UL control channel (PUCCH: Physical Uplink Control Channel), and a random access channel (PRACH: Physical Random Access Channel) as UL channels. User data and higher layer control information are conveyed on the PUSCH. Uplink Control Information (UCI) including at least one of transmission acknowledgement information (A/N or HARQ-ACK) and Channel State Information (CSI) of the PDSCH is conveyed on the PUSCH or the PUCCH. A random access preamble for establishing connection with a cell can be conveyed on the PRACH.

### <Radio Base Station>

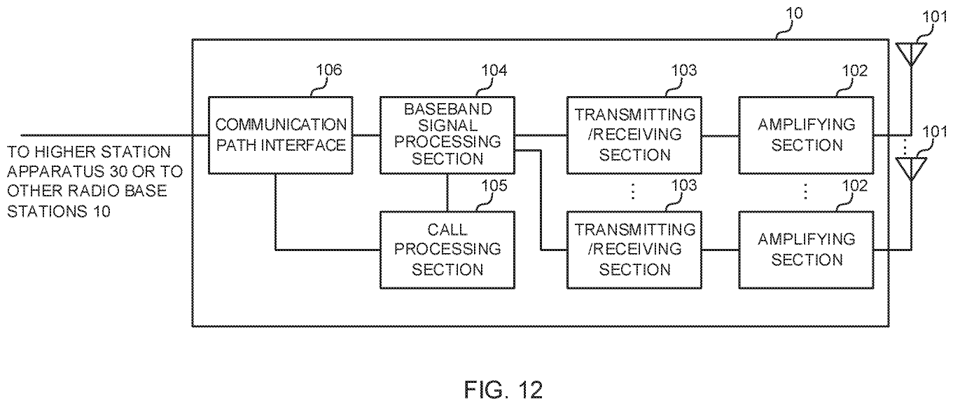

FIG. 12 is a diagram illustrating one example of an overall configuration of the radio base station according to the present embodiment. The radio base station 10 includes pluralities of transmission/reception antennas 101, amplifying sections 102 and transmission/reception sections 103, a baseband signal processing section 104, a call processing section 105 and a channel interface 106. In this regard, the radio base station 10 only needs to be configured to include one or more of each of the transmission/reception antennas 101, the amplifying sections 102 and the transmission/reception sections 103.

User data transmitted from the radio base station 10 to the user terminal 20 on downlink is input from the higher station apparatus 30 to the baseband signal processing section 104 via the channel interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., Hybrid Automatic Repeat reQuest (HARQ) processing), and transmission processing such as at least one of scheduling, transmission format selection, channel coding, rate matching, scrambling, Inverse Fast Fourier Transform (IFFT) processing, and precoding processing on the user data, and transfers the user data to each transmission/reception section 103. Furthermore, the baseband signal processing section 104 performs transmission processing such as channel coding and/or inverse fast Fourier transform on a downlink control signal, too, and transfers the downlink control signal to each transmission/reception section 103.

Each transmission/reception section 103 converts a baseband signal precoded and output per antenna from the baseband signal processing section 104 into a radio frequency band, and transmits a radio frequency signal. The radio frequency signal subjected to frequency conversion by each transmission/reception section 103 is amplified by each amplifying section 102, and is transmitted from each transmission/reception antenna 101.

The transmission/reception sections 103 can be composed of transmitters/receivers, transmission/reception circuits or transmission/reception apparatuses described based on a common knowledge in a technical field according to the present invention. In this regard, the transmission/reception sections 103 may be composed as an integrated transmission/reception section or may be composed of transmission sections and reception sections.

Meanwhile, each amplifying section 102 amplifies a radio frequency signal received by each transmission/reception antenna 101 as a UL signal. Each transmission/reception section 103 receives the UL signal amplified by each amplifying section 102. Each transmission/reception section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, reception processing of MAC retransmission control, and reception processing of an RLC layer and a PDCP layer on UL data included in the input UL signal, and transfers the UL data to the higher station apparatus 30 via the channel interface 106. The call processing section 105 performs at least one of call processing such as configuration and release of a communication channel, state management of the radio base station 10, and radio resource management.

The channel interface 106 transmits and receives signals to and from the higher station apparatus 30 via a given interface. Furthermore, the channel interface 106 may transmit and receive (backhaul signaling) signals to and from the neighboring radio base station 10 via an inter-base station interface (e.g., optical fibers compliant with the Common Public Radio Interface (CPRI) or the X2 interface).

Furthermore, each transmission/reception section 103 performs transmission of a DL signal and/or reception of a UL signal to be scheduled by applying at least one of a first time unit (e.g., slot unit) and a second time unit (e.g., a mini slot unit or a symbol unit) shorter than the first time unit. Furthermore, each transmission/reception section 103 allocates a reference signal used for demodulation of the DL signal to a given position and transmits the reference signal based on the time unit to be applied to the scheduling.

Furthermore, each transmission/reception section 103 transmits and receives the DL signal and/or the UL signal to which a DFT-spread-OFDM waveform (single carrier waveform) and/or a CP-OFDM waveform (multicarrier waveform) are applied. Furthermore, each transmission/reception section 103 may notify the user terminal of at least one of whether or not frequency hopping is applied to the UL signal and/or the UL channel (e.g., a UL shared channel and/or UCI), a waveform and a mapping method (mapping direction) to be applied. Furthermore, each transmission/reception section 103 may notify the user terminal of at least one of whether or not frequency hopping is applied to the DL signal and/or the DL channel (e.g., DL shared channel), a waveform and a mapping method (mapping direction) to be applied.

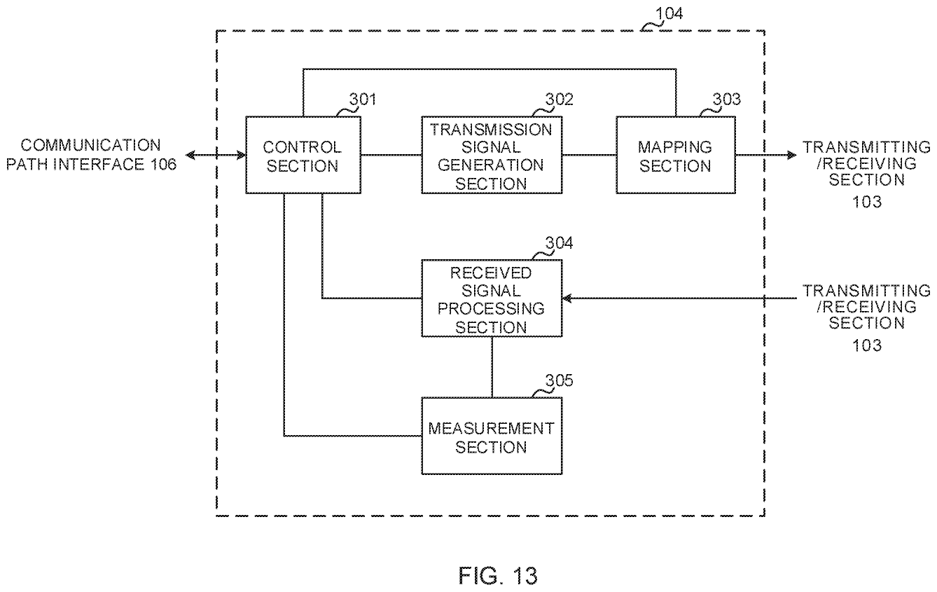

FIG. 13 is a diagram illustrating one example of a function configuration of the radio base station according to the present embodiment. In addition, FIG. 13 mainly illustrates function blocks of characteristic portions according to the present embodiment, and assumes that the radio base station 10 includes other function blocks, too, that are necessary for radio communication. As illustrated in FIG. 13, the baseband signal processing section 104 includes a control section 301, a transmission signal generating section 302, a mapping section 303, a received signal processing section 304 and a measurement section 305.

The control section 301 controls the entire radio base station 10. The control section 301 controls at least one of, for example, DL signal generation of the transmission signal generating section 302, DL signal mapping of the mapping section 303, UL signal reception processing (e.g., demodulation) of the received signal processing section 304, and measurement of the measurement section 305.

More specifically, the control section 301 schedules the user terminal 20. For example, the control section 301 may schedule and/or control retransmission of the DL data and/or the UL data channel based on the UCI (e.g., CSI) from the user terminal 20.

Furthermore, the control section 301 may control an allocation position of the UL signal and/or an allocation position of the reference signal used for demodulation of the DL signal based on the time unit applied to scheduling. When, for example, the first time unit is applied to scheduling on UL and/or DL, the control section 301 may restrict the allocation position and/or the duration of the uplink control channel used for transmission of the UL signal. Furthermore, when the second time unit is applied to scheduling on UL and/or DL, the control section 301 may notify the allocation position and/or the duration of the uplink control channel used for transmission of the UL signal without restriction.

The control section 301 can be composed of a controller, a control circuit or a control apparatus described based on the common knowledge in the technical field according to the present invention.

The transmission signal generating section 302 generates a DL signal (such as a DL data signal, a DL control signal or a DL reference signal) based on an instruction from the control section 301, and outputs the DL signal to the mapping section 303.

The transmission signal generating section 302 can be composed of a signal generator, a signal generating circuit or a signal generating apparatus described based on the common knowledge in the technical field according to the present invention.

The mapping section 303 maps the DL signal generated by the transmission signal generating section 302, on a given radio resource based on the instruction from the control section 301, and outputs the DL signal to each transmission/reception section 103. The mapping section 303 can be composed of a mapper, a mapping circuit or a mapping apparatus described based on the common knowledge in the technical field according to the present invention.

The received signal processing section 304 performs reception processing (e.g., demapping, demodulation and decoding) on a UL signal (including, for example, a UL data signal, a UL control signal and a UL reference signal) transmitted from the user terminal 20. More specifically, the received signal processing section 304 may output a received signal and/or a signal after the reception processing to the measurement section 305. Furthermore, the received signal processing section 304 performs UCI reception processing based on a UL control channel configuration instructed by the control section 301.

The measurement section 305 performs measurement related to the received signal. The measurement section 305 can be composed of a measurement instrument, a measurement circuit or a measurement apparatus described based on the common knowledge in the technical field according to the present invention.

The measurement section 305 may measure UL channel quality based on, for example, received power (e.g., Reference Signal Received Power (RSRP)) and/or received quality (e.g., Reference Signal Received Quality (RSRQ)) of a UL reference signal. The measurement section 305 may output a measurement result to the control section 301.

### <User Terminal>

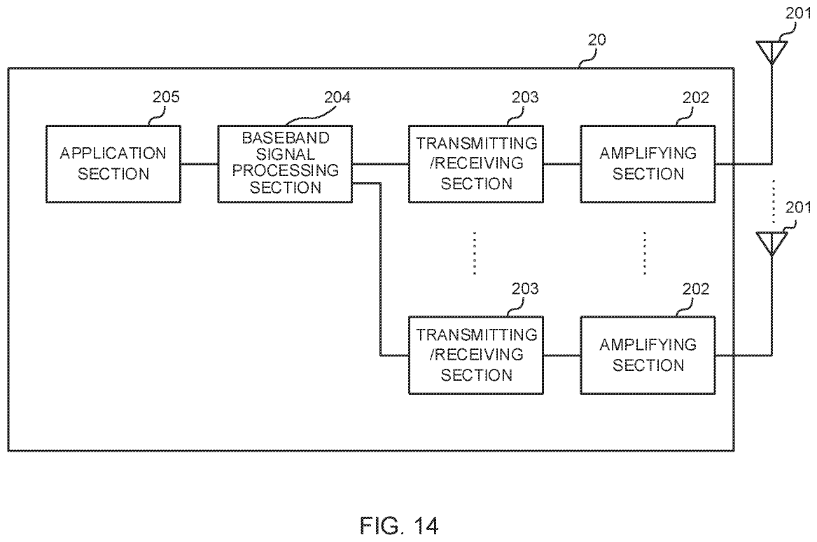

FIG. 14 is a diagram illustrating one example of an overall configuration of the user terminal according to the present embodiment. The user terminal 20 includes pluralities of transmission/reception antennas 201 for MIMO transmission, amplifying sections 202 and transmission/reception sections 203, a baseband signal processing section 204 and an application section 205.

The respective amplifying sections 202 amplify radio frequency signals received at a plurality of transmission/reception antenna 201. Each transmission/reception section 203 receives a DL signal amplified by each amplifying section 202. Each transmission/reception section 203 performs frequency conversion on the received signal into a baseband signal, and outputs the baseband signal to the baseband signal processing section 204.

The baseband signal processing section 204 performs at least one of FFT processing, error correcting decoding, and reception processing of retransmission control on the input baseband signal. The baseband signal processing section 204 transfers DL data to the application section 205. The application section 205 performs processing related to layers higher than a physical layer and an MAC layer.

On the other hand, the application section 205 inputs UL data to the baseband signal processing section 204. The baseband signal processing section 204 performs at least one of retransmission control processing (e.g., HARQ processing), channel coding, rate matching, puncturing, Discrete Fourier Transform (DFT) processing and IFFT processing on the UL data, and transfers the UL data to each transmission/reception section 203. The baseband signal processing section 204 performs at least one of channel coding, rate matching, puncturing, DFT processing and IFFT processing on the UCI (e.g., at least one of A/N of the DL signal, Channel State information (CSI) and a Scheduling Request (SR)), and transfers the UCI to each transmission/reception section 203.

Each transmission/reception section 203 converts the baseband signal output from the baseband signal processing section 204 into a radio frequency band, and transmits a radio frequency signal. The radio frequency signal subjected to the frequency conversion by each transmission/reception section 203 is amplified by each amplifying section 202, and is transmitted from each transmission/reception antenna 201.

Furthermore, each transmission/reception section 203 performs reception of the DL signal and/or transmission of the UL signal to be scheduled by applying at least one of the first time unit (e.g., slot unit) and the second time unit (e.g., the mini slot unit or the symbol unit) shorter than the first time unit. Furthermore, each transmission/reception section 203 receives a DL signal demodulation reference signal to be allocated to a given position, based on the time unit to be applied to scheduling.

Furthermore, each transmission/reception section 203 transmits the UL signal by using the uplink shared channel and/or the uplink control channel. Furthermore, each transmission/reception section 203 transmits and receives the DL signal and/or the UL signal to which the DFT-spread-OFDM waveform (single carrier waveform) and/or the CP-OFDM waveform (multicarrier waveform) are applied. Furthermore, each transmission/reception section 203 may receive at least one of whether or not frequency hopping is applied to the UL signal and/or the UL channel (e.g., the UL shared channel and/or the UCI), a waveform and a mapping method (mapping direction) to be applied. Furthermore, each transmission/reception section 203 may receive at least one of whether or not frequency hopping is applied to the DL signal and/or the DL channel (e.g., the DL shared channel), a waveform and a mapping method (mapping direction) to be applied.

The transmission/reception sections 203 can be composed as transmitters/receivers, transmission/reception circuits or transmission/reception apparatuses described based on the common knowledge in the technical field according to the present invention. Furthermore, the transmission/reception sections 203 may be composed as an integrated transmission/reception section or may be composed of transmission sections and reception sections.

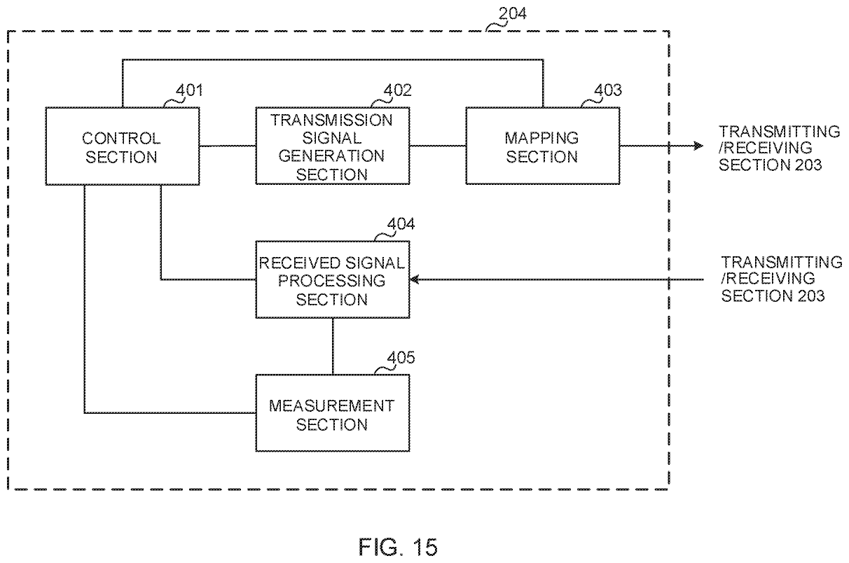

FIG. 15 is a diagram illustrating one example of a function configuration of the user terminal according to the present embodiment. In addition, FIG. 15 mainly illustrates function blocks of characteristic portions according to the present embodiment, and assumes that the user terminal 20 includes other function blocks, too, that are necessary for radio communication. As illustrated in FIG. 15, the baseband signal processing section 204 of the user terminal 20 includes a control section 401, a transmission signal generating section 402, a mapping section 403, a received signal processing section 404 and a measurement section 405.

The control section 401 controls the entire user terminal 20. The control section 401 controls at least one of, for example, UL signal generation of the transmission signal generating section 402, UL signal mapping of the mapping section 403, DL signal reception processing of the received signal processing section 404 and measurement of the measurement section 405.

Furthermore, the control section 401 controls reception of the DL signal and/or transmission of the UL signal to be scheduled by applying at least one of the first time unit and the second time unit shorter than the first time unit. The control section 401 may control the allocation position of the UL signal and/or the allocation position of the reference signal used for demodulation of the DL signal based on the time unit to be applied to scheduling.

There may be employed a configuration where, when the first time unit is applied to scheduling on UL and/or DL, the allocation position and/or the duration of the uplink control channel used for transmission of the UL signal are restricted. There may be employed a configuration where, when the second time unit is applied to scheduling on UL and/or DL, the allocation position and/or the duration of the uplink control channel used for transmission of the UL signal are not restricted.

Furthermore, when the uplink shared channel is scheduled to a slot to which the UL signal is allocated, the control section 401 may select an uplink channel used for transmission of the UL signal based on the uplink control channel configuration configured to the slot.

Furthermore, irrespectively of the time unit to be applied to scheduling on UL and/or DL, the control section 401 may control to arrange the reference signal used for demodulation of the uplink shared channel on a symbol arranged at least first in the time-domain to which the uplink shared channel is allocated.

The control section 401 can be composed of a controller, a control circuit or a control apparatus described based on the common knowledge in the technical field according to the present invention.

The transmission signal generating section 402 generates (e.g., encodes, rate-matches, punctures and modulates) a UL signal (including a UL data signal, a UL control signal, a UL reference signal and UCI) based on an instruction from the control section 401, and outputs the UL signal to the mapping section 403. The transmission signal generating section 402 can be composed of a signal generator, a signal generating circuit or a signal generating apparatus described based on the common knowledge in the technical field according to the present invention.

The mapping section 403 maps the UL signal generated by the transmission signal generating section 402, on a radio resource based on the instruction from the control section 401, and outputs the UL signal to each transmission/reception section 203. The mapping section 403 can be composed of a mapper, a mapping circuit or a mapping apparatus described based on the common knowledge in the technical field according to the present invention.

The received signal processing section 404 performs reception processing (e.g., demapping, demodulation and decoding) on the DL signal (a DL data signal, scheduling information, a DL control signal or a DL reference signal). The received signal processing section 404 outputs information received from the radio base station 10 to the control section 401. The received signal processing section 404 outputs, for example, broadcast information, system information, higher layer control information of higher layer signaling such as RRC signaling and physical layer control information (L1/L2 control information) to the control section 401.

The received signal processing section 404 can be composed of a signal processor, a signal processing circuit or a signal processing apparatus described based on the common knowledge in the technical field according to the present invention. Furthermore, the received signal processing section 404 can compose the reception section according to the present invention.

The measurement section 405 measures a channel state based on a reference signal (e.g., CSI-RS) from the radio base station 10, and outputs a measurement result to the control section 401. In addition, the measurement section 405 may measure the channel state per CC.

The measurement section 405 can be composed of a signal processor, a signal processing circuit or a signal processing apparatus, and a measurement instrument, a measurement circuit or a measurement apparatus described based on the common knowledge in the technical field according to the present invention.

### <Hardware Configuration>

In addition, the block diagrams used to describe the above embodiment illustrate blocks in function units. These function blocks (components) are realized by an optional combination of hardware and/or software. Furthermore, a method for realizing each function block is not limited in particular. That is, each function block may be realized by using one physically and/or logically coupled apparatus or may be realized by using a plurality of these apparatuses formed by connecting two or more physically and/or logically separate apparatuses directly and/or indirectly (by using, for example, wired connection and/or radio connection).

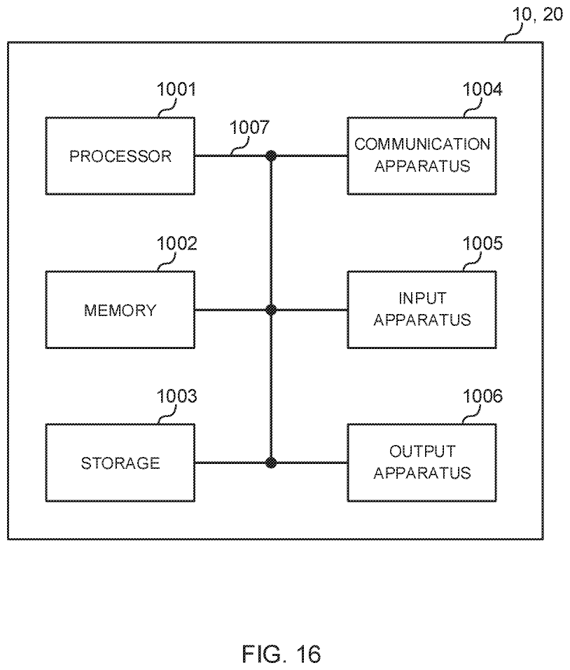

For example, the radio base station and the user terminal according to the present embodiment may function as computers that perform processing of the radio communication method according to the present invention. FIG. 16 is a diagram illustrating one example of the hardware configurations of the radio base station and the user terminal according to the present embodiment. The above radio base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, a word “apparatus” in the following description can be read as a circuit, a device or a unit. The hardware configurations of the radio base station 10 and the user terminal 20 may be configured to include one or a plurality of apparatuses illustrated in FIG. 16 or may be configured without including part of the apparatuses.

For example, FIG. 16 illustrates the only one processor 1001. However, there may be a plurality of processors. Furthermore, processing may be executed by one processor or processing may be executed by one or more processors concurrently, successively or by using another method. In addition, the processor 1001 may be implemented by one or more chips.

Each function of the radio base station 10 and the user terminal 20 is realized by, for example, causing hardware such as the processor 1001 and the memory 1002 to read given software (program), and thereby causing the processor 1001 to perform an operation, and control communication via the communication apparatus 1004 and reading and/or writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above baseband signal processing section 104 (204) and call processing section 105 may be realized by the processor 1001.

Furthermore, the processor 1001 reads programs (program codes), a software module or data from the storage 1003 and/or the communication apparatus 1004 out to the memory 1002, and executes various types of processing according to these programs, software module or data. As the programs, programs that cause the computer to execute at least part of the operations described in the above embodiment are used. For example, the control section 401 of the user terminal 20 may be realized by a control program stored in the memory 1002 and operating on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to carry out the radio communication method according to the present embodiment.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via a wired and/or radio network, and is also referred to as, for example, a network device, a network controller, a network card and a communication module. The communication apparatus 1004 may be configured to include a high frequency switch, a duplexer, a filter and a frequency synthesizer to realize, for example, Frequency Division Duplex (FDD) and/or Time Division Duplex (TDD). For example, the above transmission/reception antennas 101 (201), amplifying sections 102 (202), transmission/reception sections 103 (203) and channel interface 106 may be realized by the communication apparatus 1004.

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using buses that are different between apparatuses.

Furthermore, the radio base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or all of each function block. For example, the processor 1001 may be implemented by using at least one of these types of hardware.

### Modified Example

In addition, each term that has been described in this description and/or each term that is necessary to understand this description may be replaced with terms having identical or similar meanings. For example, a channel and/or a symbol may be signals (signaling). Furthermore, a signal may be a message. A reference signal can be also abbreviated as an RS (Reference Signal), or may be also referred to as a pilot or a pilot signal depending on standards to be applied. Furthermore, a Component Carrier (CC) may be referred to as a cell, a frequency carrier and a carrier frequency.

Furthermore, a radio frame may include one or a plurality of durations (frames) in a time-domain. Each of one or a plurality of durations (frames) that composes a radio frame may be referred to as a subframe. Furthermore, the subframe may include one or a plurality of slots in the time-domain. The subframe may be a fixed time duration (e.g., 1 ms) that does not depend on the numerologies.

Furthermore, the slot may include one or a plurality of symbols (Orthogonal Frequency Division Multiplexing (OFDM) symbols or Single Carrier-Frequency Division Multiple Access (SC-FDMA) symbols) in the time-domain. Furthermore, the slot may be a time unit based on the numerologies. Furthermore, the slot may include a plurality of mini slots. Each mini slot may include one or a plurality of symbols in the time-domain. Furthermore, the mini slot may be referred to as a subslot.

The radio frame, the subframe, the slot, the mini slot and the symbol each indicate a time unit for conveying signals. The other corresponding names may be used for the radio frame, the subframe, the slot, the mini slot and the symbol. For example, 1 subframe may be referred to as a Transmission Time Interval (TTI), a plurality of contiguous subframes may be referred to as TTIs, or 1 slot or 1 mini slot may be referred to as a TTI. That is, the subframe and/or the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as a slot or a mini slot instead of a subframe.

In this regard, the TTI refers to, for example, a minimum time unit of scheduling for radio communication. For example, in the LTE system, the radio base station performs scheduling for allocating radio resources (a frequency bandwidth or transmission power that can be used by each user terminal) in TTI units to each user terminal. In this regard, a definition of the TTI is not limited to this.

The TTI may be a transmission time unit of a channel-coded data packet (transport block), code block and/or codeword, or may be a processing unit of scheduling or link adaptation. In addition, when the TTI is given, a time interval (e.g., the number of symbols) in which a transport block, a code block and/or a codeword are actually mapped may be shorter than the TTI.

In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that compose a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe or a long subframe. A TTI shorter than the general TTI may be referred to as a reduced TTI, a short TTI, a partial or fractional TTI, a reduced subframe, a short subframe, a mini slot or a subslot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

Resource Blocks (RBs) are resource allocation units of the time-domain and the frequency-domain, and may include one or a plurality of contiguous subcarriers in the frequency-domain. Furthermore, the RB may include one or a plurality of symbols in the time-domain or may have the length of 1 slot, 1 mini slot, 1 subframe or 1 TTI. 1 TTI or 1 subframe may each include one or a plurality of resource blocks. In this regard, one or a plurality of RBs may be referred to as a Physical Resource Block (PRB: Physical RB), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

In this regard, structures of the above radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and parameters described in this description may be expressed by using absolute values, may be expressed by using relative values with respect to given values or may be expressed by using other corresponding information. For example, a radio resource may be instructed by a given index.

Names used for parameters in this description are in no respect restrictive ones. For example, various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive names.

The information and the signals described in this description may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or optional combinations of these.

Furthermore, the information and the signals can be output from a higher layer to a lower layer and/or from the lower layer to the higher layer. The information and the signals may be input and output via a plurality of network nodes.

The input and output information and signals may be stored in a specific location (e.g., memory) or may be managed by using a management table. The information and signals to be input and output can be overwritten, updated or additionally written. The output information and signals may be deleted. The input information and signals may be transmitted to other apparatuses.

Notification of information is not limited to the aspects/embodiment described in this description and may be performed by using other methods. For example, the information may be notified by physical layer signaling (e.g., Downlink Control Information (DCI) and Uplink Control Information (UCI)), higher layer signaling (e.g., Radio Resource Control (RRC) signaling, broadcast information (Master Information Blocks (MIBs) and System Information Blocks (SIBs)), and Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnection Reconfiguration message. Furthermore, the MAC signaling may be notified by using, for example, an MAC Control Element (MAC CE).

Furthermore, notification of given information (e.g., notification of “being X”) may be made not only by explicit notification but also implicit notification (by, for example, not notifying this given information or by notifying another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using wired techniques (e.g., coaxial cables, optical fiber cables, twisted pairs and Digital Subscriber Lines (DSL)) and/or radio techniques (e.g., infrared rays and microwaves), these wired techniques and/or radio techniques are included in a definition of the transmission media.

The terms “system” and “network” used in this description are compatibly used.

In this description, the terms “Base Station (BS)”, “radio base station”, “eNB”, “gNB”, “cell”, “sector”, “cell group”, “carrier” and “component carrier” can be compatibly used. The base station is also referred to as a term such as a fixed station, a NodeB, an eNodeB (eNB), an access point, a transmission point, a reception point, a femtocell or a small cell in some cases.

The base station can accommodate one or a plurality of (e.g., three) cells (also referred to as sectors). When the base station accommodates a plurality of cells, an entire coverage area of the base station can be partitioned into a plurality of smaller areas. Each smaller area can provide communication service via a base station subsystem (e.g., indoor small base station (RRH: Remote Radio Head)). The term “cell” or “sector” indicates part or the entirety of the coverage area of the base station and/or the base station subsystem that provide communication service in this coverage.

In this description, the terms “Mobile Station (MS)”, “user terminal”, “User Equipment (UE)” and “terminal” can be compatibly used. The base station is also referred to as a term such as a fixed station, a NodeB, an eNodeB (eNB), an access point, a transmission point, a reception point, a femtocell or a small cell in some cases.

The mobile station is also referred to by a person skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

Furthermore, the radio base station in this description may be read as the user terminal. For example, each aspect/embodiment of the present invention may be applied to a configuration where communication between the radio base station and the user terminal is replaced with communication between a plurality of user terminals (D2D: Device-to-Device). In this case, the user terminal 20 may be configured to include the functions of the above radio base station 10. Furthermore, words such as “uplink” and “downlink” may be read as a “side”. For example, the uplink channel may be read as a side channel.

Similarly, the user terminal in this description may be read as the radio base station. In this case, the radio base station 10 may be configured to include the functions of the above user terminal 20.

In this description, operations performed by the base station are performed by an upper node of this base station depending on cases. Obviously, in a network including one or a plurality of network nodes including the base stations, various operations performed to communicate with a terminal can be performed by base stations, one or more network nodes (that are supposed to be, for example, Mobility Management Entities (MME) or Serving-Gateways (S-GW) yet are not limited to these) other than the base stations or a combination of these.

Each aspect/embodiment described in this description may be used alone, may be used in combination or may be switched and used when carried out. Furthermore, orders of the processing procedures, the sequences and the flowchart according to each aspect/embodiment described in this description may be rearranged unless contradictions arise. For example, the method described in this description presents various step elements in an exemplary order and is not limited to the presented specific order.

Each aspect/embodiment described in this description may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods and/or next-generation systems that are expanded based on these systems.

The phrase “based on” used in this description does not mean “based only on” unless specified otherwise. In other words, the phrase “based on” means both of “based only on” and “based at least on”.

Every reference to elements that use names such as “first” and “second” used in this description does not generally limit the quantity or the order of these elements. These names can be used in this description as a convenient method for distinguishing between two or more elements. Hence, the reference to the first and second elements does not mean that only two elements can be employed or the first element should precede the second element in some way.

The term “deciding (determining)” used in this description includes diverse operations in some cases. For example, “deciding (determining)” may be regarded to “decide (determine)” calculating, computing, processing, deriving, investigating, looking up (e.g., looking up in a table, a database or another data structure) and ascertaining. Furthermore, “deciding (determining)” may be regarded to “decide (determine)” receiving (e.g., receiving information), transmitting (e.g., transmitting information), input, output and accessing (e.g., accessing data in a memory). Furthermore, “deciding (determining)” may be regarded to “decide (determine)” resolving, selecting, choosing, establishing and comparing. That is, “deciding (determining)” may be regarded to “decide (determine)” some operation.

The words “connected” and “coupled” used in this description or every modification of these words can mean every direct or indirect connection or coupling between two or more elements, and can include that one or more intermediate elements exist between the two elements “connected” or “coupled” with each other. The elements may be coupled or connected physically, logically or by way of a combination of the physical and logical connections. For example, “connection” may be read as “access”.

It can be understood that, when connected in this description, the two elements are “connected” or “coupled” with each other by using one or more electric wires, cables and/or printed electrical connection, and by using electromagnetic energy having wavelengths in radio frequency domains, microwave domains and/or (both of visible and invisible) light domains in some non-restrictive and non-comprehensive examples.

A sentence that “A and B are different” in this description may mean that “A and B are different from each other”. Words such as “separate” and “coupled” may be also interpreted in a similar manner.

When the words “including” and “comprising” and modifications of these words are used in this description or the claims, these words intend to be comprehensive similar to the word “having”. Furthermore, the word “or” used in this description or the claims intends not to be an exclusive OR.

The present invention has been described in detail above. However, it is obvious for a person skilled in the art that the present invention is not limited to the embodiment described in this description. The present invention can be carried out as modified and changed aspects without departing from the gist and the scope of the present invention defined based on the recitation of the claims. Accordingly, the disclosure of this description intends for exemplary explanation, and does not bring any restrictive meaning to the present invention.

1. A user terminal comprising:
a control section that controls reception of a DL signal and/or transmission of a UL signal to be scheduled by applying at least one of a first time unit and a second time unit shorter than the first time unit; and
a transmission section that transmits the UL signal by using an uplink shared channel and/or an uplink control channel,
wherein an allocation position of the UL signal and/or an allocation position of a reference signal used for demodulation of the DL signal are controlled based on a time unit to be applied to the scheduling.

2. The user terminal according to claim 1, wherein, when the first time unit is applied to the scheduling on UL and/or DL, an allocation position and/or a duration of an uplink control channel used for the transmission of the UL signal are restricted.

3. The user terminal according to claim 1, wherein, when the uplink shared channel is scheduled for a given first time unit in which the UL signal is allocated, the control section selects an uplink channel used for the transmission of the UL signal based on a configuration of the uplink control channel configured in the given first time unit.

4. The user terminal according to claim 1, wherein, when the second time unit is applied to scheduling on UL and/or DL, an allocation position and/or a duration of the uplink control channel used for the transmission of the UL signal are not restricted.

5. The user terminal according to claim 1, wherein the control section performs control to arrange a reference signal on a symbol irrespectively of a time unit to be applied to scheduling on UL and/or DL, the reference signal being used for demodulation of the uplink signal, and the symbol being arranged at least first in a time-domain to which the uplink shared channel is allocated.

6. A radio communication method of a user terminal comprising:
controlling reception of a DL signal and/or transmission of a UL signal to be scheduled by applying at least one of a first time unit and a second time unit shorter than the first time unit; and
transmitting the UL signal by using an uplink shared channel and/or an uplink control channel,
wherein an allocation position of the UL signal and/or an allocation position of a reference signal used for demodulation of the DL signal are controlled based on a time unit to be applied to the scheduling.

7. The user terminal according to claim 2, wherein, when the uplink shared channel is scheduled for a given first time unit in which the UL signal is allocated, the control section selects an uplink channel used for the transmission of the UL signal based on a configuration of the uplink control channel configured in the given first time unit.

8. The user terminal according to claim 2, wherein the control section performs control to arrange a reference signal on a symbol irrespectively of a time unit to be applied to scheduling on UL and/or DL, the reference signal being used for demodulation of the uplink signal, and the symbol being arranged at least first in a time-domain to which the uplink shared channel is allocated.

9. The user terminal according to claim 3, wherein the control section performs control to arrange a reference signal on a symbol irrespectively of a time unit to be applied to scheduling on UL and/or DL, the reference signal being used for demodulation of the uplink signal, and the symbol being arranged at least first in a time-domain to which the uplink shared channel is allocated.

10. The user terminal according to claim 4, wherein the control section performs control to arrange a reference signal on a symbol irrespectively of a time unit to be applied to scheduling on UL and/or DL, the reference signal being used for demodulation of the uplink signal, and the symbol being arranged at least first in a time-domain to which the uplink shared channel is allocated.
